(19) United States
(12) Patent Application Publication
(10) Pub. No.: US 2019/0251532 A1
(43) Pub. Date: Aug. 15, 2019

(54) SYSTEMS AND METHODS FOR PROVIDING DISTRIBUTED LICENSING AND SUBSCRIPTION MANAGEMENT

(71) Applicant: Red Hat Israel, Ltd., Raanana (IL)

(72) Inventors: Sasha Segal, Ramat Gan (IL); Alexander Braverman Masis, Raanana (IL)

(21) Appl. No.: 15/896,616

(22) Filed: Feb. 14, 2018

(51) Int. Cl. G06Q 20/12; G06Q 20/38; G06Q 20/06

(52) U.S. Cl. CPC G06Q 20/1235; G06Q 20/3829; G06Q 2220/00; G06Q 20/127; G06Q 20/06

(57) ABSTRACT

Methods, systems, and computer devices are included for license and subscription management. An example method includes receiving a license acquire transaction request from a customer node of a plurality of nodes. The license acquire transaction includes a customer node system address. The system validates the license acquire transaction, which includes authenticating the customer node. The system generates a transaction ledger block corresponding to the validated license acquire transaction, and provides the generated transaction ledger block to the customer node.

### FIELD OF DISCLOSURE

The present disclosure generally relates to multicomputer data transferring, and more specifically to distributed software license and subscription management.

### BACKGROUND

Conventional mechanisms for license and subscription management over distributed systems include requiring each system to register with a centralized identity management system. As further development occurs with respect to the license, new license versions are released via the centralized identify management system that include additional features and/or correct earlier defects in the license.

### SUMMARY

A system of one or more computers can be configured to perform particular operations or actions by virtue of having software, firmware, hardware, or a combination thereof installed on the system that in operation causes or cause the system to perform the actions. One or more computer programs can be configured to perform particular operations or actions by virtue of including instructions that, when executed by data processing apparatus, cause the apparatus to perform the actions. One general aspect includes a system, including: a non-transitory memory; and one or more hardware processors coupled to the non-transitory memory and configured to read instructions from the non-transitory memory to cause the system to perform operations including: receiving a license acquire transaction request from a customer node, the license acquire transaction request including a customer node system address; validating the license acquire transaction, the validating including authenticating the customer node; generating a transaction ledger block corresponding to the license acquire transaction, the transaction ledger block including a block identifier and a license identifier; and providing the generated transaction ledger block to the customer node. Other examples of this aspect include corresponding computer systems, apparatus, and computer programs recorded on one or more computer storage devices, each configured to perform the actions of the methods.

One general aspect includes a non-transitory machine-readable medium having stored thereon machine-readable instructions executable to cause a machine to perform operations including: receiving a license acquire transaction request from a customer node, the license acquire transaction request including a customer node system address; validating the license acquire transaction, the validating including authenticating the customer node; generating a transaction ledger block corresponding to the license acquire transaction, the transaction ledger block including a block identifier and a license identifier; and providing the generated transaction ledger block to the customer node. Other examples of this aspect include corresponding computer systems, apparatus, and computer programs recorded on one or more computer storage devices, each configured to perform the actions of the methods.

One general aspect includes a method including: receiving a license acquire transaction request from a customer node, the license acquire transaction request including a customer node system address; validating the license acquire transaction, the validating including authenticating the customer node; generating a transaction ledger block corresponding to the license acquire transaction, the transaction ledger block including a block identifier and a license identifier; and providing the generated transaction ledger block to the customer node. Other examples of this aspect include corresponding computer systems, apparatus, and computer programs recorded on one or more computer storage devices, each configured to perform the actions of the methods.

### BRIEF DESCRIPTION OF THE DRAWINGS

FIG. 1 is an organizational diagram illustrating a system 100 that processes a license acquire transaction request from a customer node 106 and provides a generated transaction ledger block 124, in accordance with various examples of the present disclosure.

FIG. 2 is a flow diagram illustrating a method 200 for performing a license acquire transaction, in accordance with various examples of the present disclosure.

FIG. 3a is a flow diagram illustrating a method 300 for processing a license update request, in accordance with various examples of the present disclosure.

FIG. 3b is a flow diagram illustrating a method 308 for processing a license transfer request, in accordance with various examples of the present disclosure.

FIG. 3c is a flow diagram illustrating a method 316 for processing a license block request, in accordance with various examples of the present disclosure.

FIG. 3d is an illustration 326 of what the generated transaction ledger block 328 may contain, in accordance with various examples of the present disclosure.

FIG. 3e is an illustration 344 of what the license acquire transaction request 346 may contain, in accordance with various examples of the present disclosure.

FIG. 4 is an organizational diagram of a computing device, in accordance with various examples of the present disclosure.

Examples of the present disclosure and their advantages are best understood by referring to the detailed description that follows.

### DETAILED DESCRIPTION

In the following description, specific details are set forth describing some examples consistent with the present disclosure. It will be apparent, however, to one skilled in the art that some examples may be practiced without some or all of these specific details. The specific examples disclosed herein are meant to be illustrative but not limiting. One skilled in the art may realize other elements that, although not specifically described here, are within the scope and the spirit of this disclosure. In addition, to avoid unnecessary repetition, one or more features shown and described in association with one example may be incorporated into other examples unless specifically described otherwise or if the one or more features would make an example non-functional.

Requiring each system to register with the centralized identity management system is not always advantageous. For example, implementing licensing using a centralized identity system impedes transfers of licenses via a secondary market, such that customers are bound to the full lifetime of licenses even if the licensed software is no longer in use.

The techniques herein provide useful advantages to license and subscription management technology. For instance, the techniques allow the license and subscription management system to be de-centralized and for management of the licenses and subscriptions to be spread among the users of the license and subscription management system. This reduces management overhead and upkeep costs by obviating the need for centralized servers. Thus, processing and storage resource costs are reduced, yielding efficiency improvements to the computing system providing the license and subscription management system.

Moreover, the license and subscription management system is improved because it does not have a single point of failure, and is therefore less susceptible to failure and more resilient to errors that may occur to any particular nodes in the network. For example, thousands or even millions of computing devices may share responsibility for management of the license and subscription management system, such that even the total failure of any machine in the network has little impact on the license and subscription management system. Furthermore, a secondary market for licenses and subscriptions is created, where a user may sell or transfer a license to another user. Of course, it is understood that these features and advantages are shared among the various examples herein and that no one feature or advantage is required for any particular example.

A customer node in a distributed system may wish to acquire a license from the license and subscription management system. The customer node may then send a license acquire transaction request to the license and subscription management system. The license acquire transaction request may include, for example, the customer node system address. Upon receiving the license acquire transaction request from the customer node, the license and subscription management system may validate the license acquire transaction, which may include authenticating the customer node. The license and subscription management system may then generate a transaction ledger block that corresponds to the license acquire transaction, which may include a block identifier and a license identifier. The license and subscription management system may then provide the generated transaction ledger block to the customer node.

The customer node may wish to transfer a particular license to another node. The license and subscription management system may receive a license transfer request from the customer node, which may include the customer node system address and a transfer node identifier, which identifies the desired recipient node. The license and subscription management system may generate a license transfer transaction ledger block corresponding to the license transfer transaction, and the license transfer transaction ledger block may include the transfer node identifier and the license identifier. The license and subscription management system may then provide the generated license transfer transaction ledger block to the customer node and the transfer node that corresponds to the transfer node identifier.

The customer node may wish to cancel or block a particular license. The customer node may send a license block request, which may include the block identifier, to the license and subscription management system. Upon receiving the license block request from the customer node, the license and subscription management system may block the transaction ledger block corresponding to the block identifier. The license and subscription management system may then generate a new transaction ledger block corresponding to the license block transaction. The new transaction ledger block may include the customer node system address and the license identifier. The license and subscription management system may then provide the new generated transaction ledger block to the customer node.

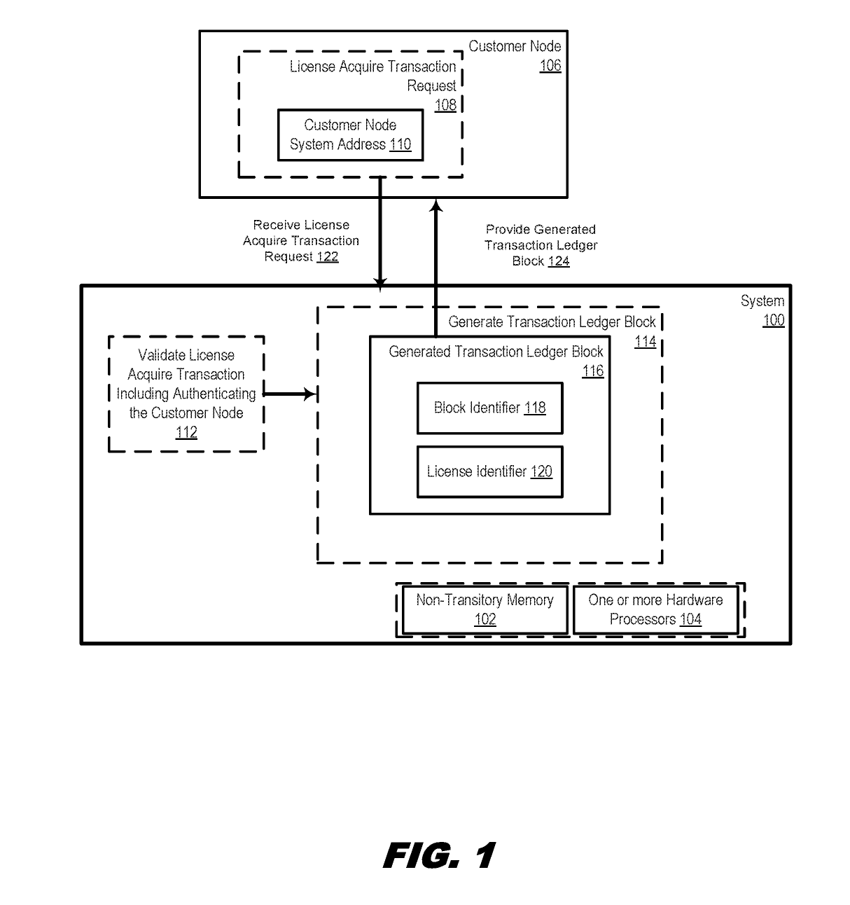

FIG. 1 is an organizational diagram illustrating a system 100 that processes a license acquire transaction request from a customer node 106 and provides a generated transaction ledger block 124, in accordance with various examples of the present disclosure.

The system 100 includes a non-transitory memory 102, and one or more hardware processors 104 coupled to the non-transitory memory 102. In the present example, the one or more hardware processors 104 executes instructions from the non-transitory memory 102 to perform operations to process a license acquire transaction request from a customer node 106 and provide a generated transaction ledger block 124. In the present example, the customer node 106 is communicatively coupled in a peer-to-peer network.

The system 100 includes customer node 106 that is structured as a computing device. In the present example, when customer node 106 is first initialized, customer node 106 generates a license acquire transaction request that includes a customer node system address 110. The customer node system address 110 cannot be copied to another node, as it is tied to the customer node 106. In some examples, the customer node system address 110 may be a unique wallet ID.

By way of further example, the customer node system address 110 may be a signature generated for the license acquire transaction using an asymmetrical cryptography technique, such as via a Public Key Infrastructure (PKI) that assigns the customer a key pair including a private key and a public key. In this example, the customer generates the signature for the license acquire transaction using the customer's private key. Both the private key and the public key may be letters and/or integer numbers.

In the present example, customer node 106 creates a license acquire transaction request 108 to acquire a license from the license and subscription management system. In the present example, the license acquire transaction request 108 includes the customer node system address 110. In some examples, the license acquire transaction request may include encrypted information, that when decrypted, may provide information regarding the contents of the license acquire transaction request 108, as well as information regarding the customer that provided the license acquire transaction request 108.

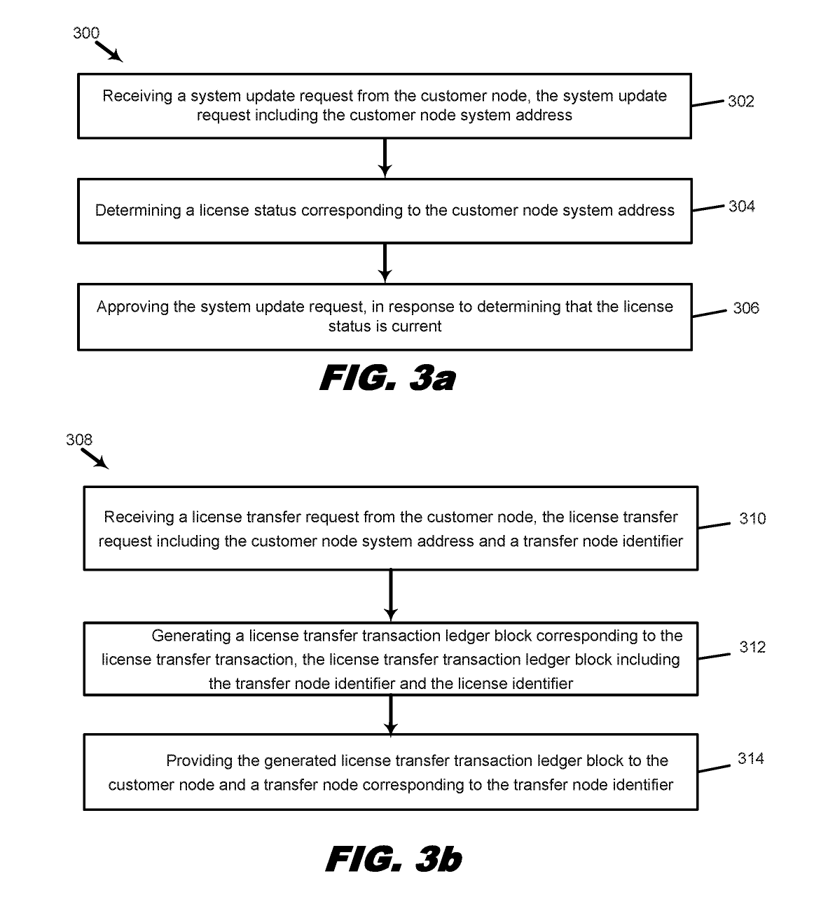

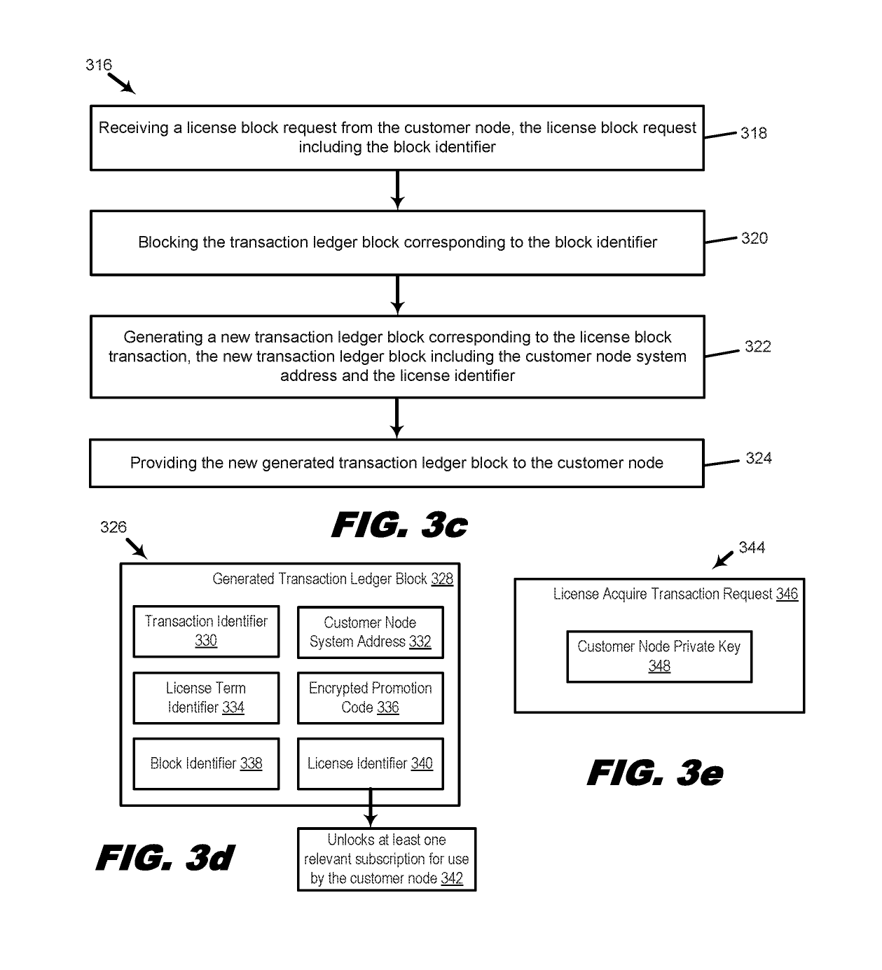

Examples of data that may be included in a license acquire transaction request are described in further detail with respect to FIG. 3e. For example, a license acquire transaction request may include a customer node private key. The private key may be known by the customer node 106, and is not shared.

In some examples, the transaction includes an indication of an amount of virtual currency to transfer from the customer to the license and subscription management system that validates the transaction. For example, the customer may have a digital wallet that holds virtual currency, and may designate an amount of the virtual currency to be withdrawn and paid to the license and subscription management system that validates the transaction.

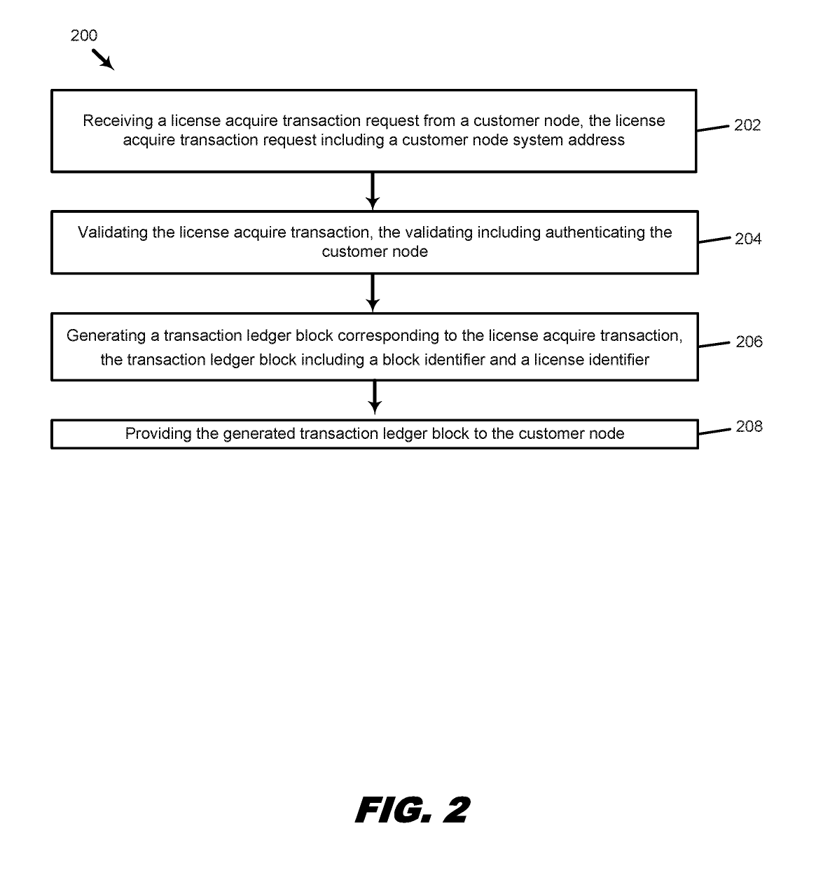

System 100 is structured to validate the customer node transaction, authenticate the customer node, generate a new transactional ledger block 114 that includes the generated transaction ledger block 116, and provide the generated transaction ledger block to the customer node 106. Techniques for validating transactions and creating transaction ledger blocks are described in more detail with respect to FIG. 2.

In the present example, the system 100 is structured to validate the license acquire transaction request and to authenticate the customer node 112. Accordingly, the license acquire transaction request is received by the system from the customer node 122.

In the present example, once the system 100 validates the license acquire transaction, which includes authenticating the customer node 112, the system 100 generates a transaction ledger block 114. For example, the generated transaction ledger block 116 may include a block identifier 118 and a license identifier 120. The block identifier 118 may be a unique id that is specific for the particular generated ledger block 116. For example, the block identifier 118 may be a cryptographic hash created through a Secure Hash Algorithm, such as, for example, SHA-256. By way of further example, the block identifier 118 may correspond to the height of the generated transaction ledger block 116 in the transaction ledger. By way of further example, the block identifier 118 may consist of letters and/or integer numbers. Examples of a license identifier 120 may include letters and/or integer numbers.

System 100 is structured to provide the generated transaction ledger block to the customer node 106. In this way, the customer node 106 in the distributed network is made aware of the completed transaction regarding the license acquire transaction request and provided. access to the requested license.

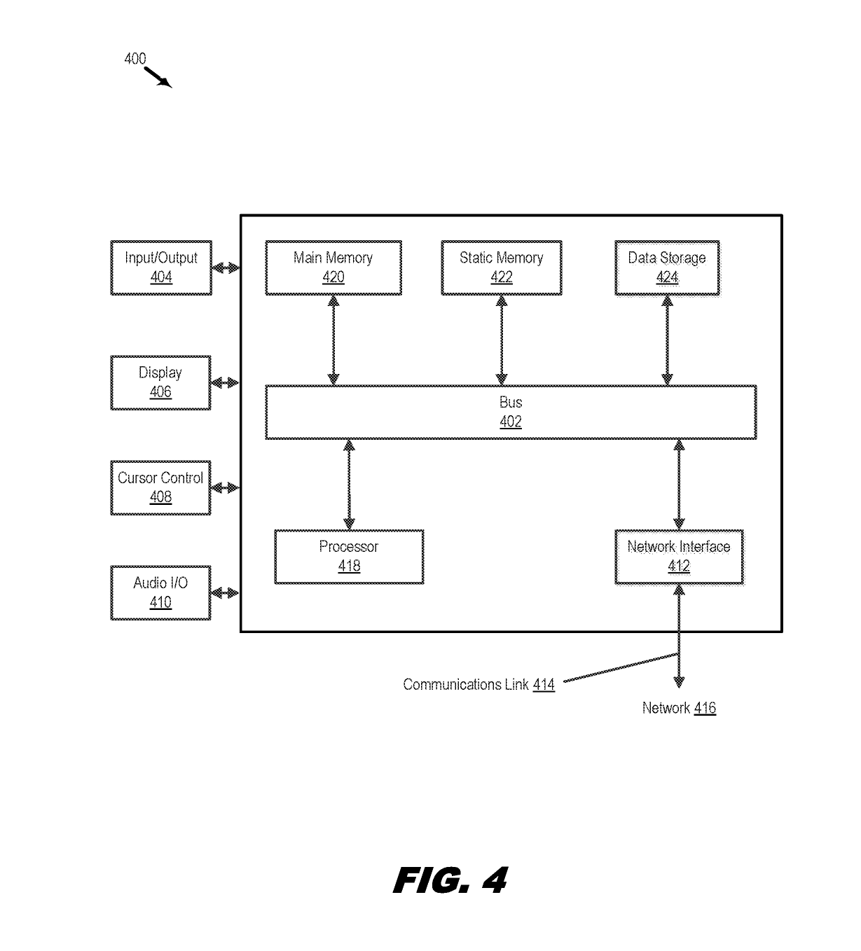

FIG. 2 is a flow diagram illustrating a method 200 for performing a license acquire transaction, in accordance with various examples of the present disclosure. In some examples, the method is performed by executing computer-readable instructions that are stored in a non-transitory memory using one or more processors. The non-transitory memory and processors may be provided by, for example, one or more of the computing devices 400 as described with respect to FIG. 4. Additional steps may be provided before, during, and after the steps of method 200, and some of the steps described may be replaced, eliminated and/or re-ordered for other examples of the method 200.

At action 202, a license and subscription management system in a peer-to-peer network receives a license acquire transaction request from a customer node. In the present example, the customer node includes a computing device that is used by a customer user to nm applications, where some applications require the acquisition of a license in order to consume the application content. In the present example, the license and subscription management system receives a license acquire transaction request from the customer node. The customer node may send the license acquire transaction request via a wallet. In other examples, other transaction requests may be received in addition to, or instead of, license acquire transaction requests.

In the present example, the license acquire transaction request includes a customer node system address. For example, the customer node system address may be a customer generated system address that cannot be copied to another node as it is tied to unique parameters of the customer node system. For example, the customer node system address may be a signature. In the present example, the signature is generated for the software package using an asymmetrical cryptography technique, such as via a Public Key Infrastructure (PKI) that assigns the customer a key pair including a private key and a public key. In this example, the customer generates the signature for the license acquire transaction request using the customer's private key. The public key is distributed to other nodes that use the public key to verify the signature. Both the private key and the public key may be letters and/or integer numbers. Examples of cryptography techniques for generating and verifying signatures include DSA, Elliptic Curve Signature, RSA, and so forth.

In some examples, the license acquire transaction request may also include a virtual currency amount, a description of the license, a license version number, a time stamp, and/or a message. In the present example, the time stamp specifies a time corresponding to the transaction, such as a time that the transaction was submitted for validation. In some examples, the time stamp specifies a year, month, day, hour, minute, and second corresponding to the transaction. In other examples, the time stamp may provide additional granularity beyond specifying the second (e.g., microsecond, and so forth).

At action 204, the license and subscription management system validates the license acquire transaction, which includes authenticating the customer node. For example, the validation of a license can be achieved by validating the customer node system address, which is unique and can be queried when needed. In some examples, the validating includes executing terms in the transaction via a smart contract protocol

In some examples, authenticating the customer node includes accessing a public key corresponding to the customer node by retrieving the public key from the transaction itself (if provided by the customer in the transaction), or by retrieving the public key from a listing of public keys that is accessible to the server via a network location. Once the public key is retrieved, the license and subscription management system inputs the signature and the public key into a signature verification function (e.g., DSA, Elliptic Curve Signature, RSA, and so forth) to decrypt the digital signature.

Once decrypted, the license and subscription management system compares information from the decrypted signature with other information to verify the authenticity of the license acquire transaction request. For example, the decrypted digital signature may include the public key and/or some other value that the server may compare to validate that the license acquire transaction request was signed using the private key that is part of the same key pair as the retrieved public key.

In more detail, the decrypted signature may provide the customer's public key and a hash corresponding to the license acquire transaction request. The license and subscription management system may compare the public key to the public key used to decrypt the signature to verify the authenticity of the customer. The license and subscription management system may compare the hash retrieved from the decrypted signature with a hash that the customer node generates from the license acquire transaction request to verify that the contents of the software package have not been tampered with or otherwise modified, such as by an unauthorized user, entity, or software program. Techniques for generating the hash from the software package include MD5, SHA-1, and so forth.

At action 206, the license and subscription management system generates a transaction ledger block, which may include a block identifier and a license identifier, corresponding to the validated license acquire transaction. In the present example, the license and subscription management system provides the license acquire transaction, in a transaction ledger block that includes one or more other transactions that have been validated by the license and subscription management system. In some examples, the transaction that is included in the transaction ledger block includes the information that is described in more detail with respect to FIG. 3d.

In the present example, the license and subscription management server assigns the transaction a transaction identifier. In some examples, the license and subscription management system assigns the transaction identifier by accessing one or more hashes included in previous transaction ledger blocks to perform a proof of work. In more detail, the proof of work may include generating a hash that includes contents from the transaction ledger and also a hash of a previous transaction ledger block. The proof of work helps protect the transaction ledger block (and the previous transaction ledger blocks) from tampering because it provides a cryptographic link between the transaction ledger block and previous transaction ledger blocks. In that regard, the hashes in the transaction identifiers help ensure that even minor changes in the previous transaction ledger block result in a different hash, thereby indicating the existence of the tampering. Moreover, if a previous transaction ledger block is tampered with, it may be identified as out of place in the linked transaction ledgers because other nodes in the network will have copies of the previous transaction ledger block that do not match the tampered-with previous transaction ledger.

At action 208, the license and subscription management system provides the generated. transaction ledger block to the customer node. In the present example, the server includes the transaction ledger block in a listing of previous transaction ledger block, and provides the transaction ledger blocks to the customer node so that the customer node may similarly include the transaction ledger block in its listing of previous transaction ledger blocks. In another example, the server includes the transaction ledger block in a listing of previous transaction ledger block, and provides the transaction ledger blocks to the other nodes so that the other nodes may similarly include the transaction ledger block in their listing of previous transaction ledger blocks.

FIG. 3a is a flow diagram illustrating a method 300 for processing a license update request, in accordance with various examples of the present disclosure. At action 302, the license and subscription management system in a peer-to-peer network receives a system update request from the customer node, where the system update request includes the customer node system address. For example, an application may require multiple licenses from the customer. As a result, for example, there may be multiple license update requests sent from the customer to the system.

At action 304, the license and subscription management system determines a license status corresponding to the customer node system address. The license status may indicate whether the license is current, expired, or unavailable. For example, a license status of current indicates that the customer previously acquired the license or that the license was previously transferred to the customer. Additionally, for example, the license also may need to be ongoing, such as by the customer paying an additional yearly, monthly, or weekly fee. By way of further example, the payment to keep the license current may be based on the customer's usage of the system's resources. Additionally, for example, a license status of expired indicates that the customer previously acquired the license or that the license was previously transferred to the customer, but that the customer has not paid to keep the license current. Moreover, for example, a license status of unavailable indicates that the customer never acquired the license or that the license was not previously transferred to the customer.

In the present example, the license and subscription management system may use the customer node system address to search the transaction ledger for a generated transaction ledger block that includes the customer node system address. For example, the generated transaction ledger block may be a result of a successful license acquire transaction request, or the generated transaction ledger block may be the result of a license transfer request. By way of further example, the license and subscription management system may use additional information, which may have been sent by the customer node, such as the name of the license, the date that the license acquire transaction request was made, or the virtual currency amount involved in the license acquire transaction request that corresponds to the license that is involved in the license update request. If the license and subscription management system finds the corresponding generated transaction ledger block, the license and subscription management system may either determine that the license status is current, or that the license status is expired, depending on additional license information contained in the generated transaction ledger block, such as the duration of the license term, the timestamp of the generated transaction ledger block, etc.

At action 306, the license and subscription management system approves the system update request, in response to determining that the license status is current. For example, if the license status is expired or unavailable, where the customer either has never acquired the license or had the license transferred to them, or the customer has not paid to keep the license ongoing, the system would not approve the system update request. By way of further example, the system may issue a denial of the system update request to the customer node in response to the license status being expired or unavailable. Additionally, for example, if the customer has either previously acquired the license or the license was previously transferred to the customer, but the customer has not paid to keep the license ongoing, the system may notify the customer of the delinquent payment.

FIG. 3b is a flow diagram illustrating a method 308 for processing a license transfer request, in accordance with various examples of the present disclosure. At action 310, the license and subscription management system in a peer-to-peer network receives a license transfer request from the customer node, where the license transfer request includes the customer node system address and a transfer node identifier. For example, a customer may wish to transfer multiple licenses to one or more transfer nodes. As a result, for example, there may be multiple license transfer requests sent from the customer to the license and subscription management system with one or more transfer nodes. By way of further example, the transfer node identifier may be the transfer node's public key or another identifier unique to the transfer node.

At action 312, the license and subscription management system generates a transfer transaction ledger block corresponding to the license transfer transaction, the transfer transaction ledger block including the transfer node identifier and the license identifier. In the present example, the license and subscription management system provides the license transfer transaction, in a transaction ledger block that includes one or more other transactions that have been validated by the license and subscription management system.

In the present example, the license and subscription management system assigns the transaction a transaction identifier. In some examples, the license and subscription management system assigns the transaction identifier by accessing one or more hashes included in previous transaction ledger blocks to perform a proof of work. In more detail, the proof of work may include generating a hash that includes contents from the transaction ledger and also a hash of a previous transaction ledger block. The proof of work helps protect the transaction ledger block (and the previous transaction ledger blocks) from tampering because it provides a cryptographic link between the transaction ledger block and previous transaction ledger blocks. In that regard, the hashes in the transaction identifiers help ensure that even minor changes in the previous transaction ledger block result in a different hash, thereby indicating the existence of the tampering. Moreover, if a previous transaction ledger block is tampered with, it may be identified as out of place in the linked transaction ledgers because other nodes in the network will have copies of the previous transaction ledger block that do not match the tampered-with previous transaction ledger.

At action 314, the license and subscription management system provides the license transfer transaction ledger block to the customer node and to a transfer node corresponding to the transfer node identifier. In the present example, the license and subscription management system includes the transaction ledger block in a listing of previous transaction ledger blocks, and provides the transaction ledger blocks to the customer node and to the transfer node the corresponds to the transfer node identifier so that the customer node and transfer node may similarly include the transaction ledger block in their listings of previous transaction ledger blocks. In another example, the license and subscription management system includes the transaction ledger block in a listing of previous transaction ledger blocks, and provides the transaction ledger blocks to the other nodes so that the other nodes may similarly include the transaction ledger block in their listing of previous transaction ledger blocks.

FIG. 3c is a flow diagram illustrating a method 316 for processing a license block request, in accordance with various examples of the present disclosure. At action 318, the license and subscription management system in a peer-to-peer network receives a license block request from the customer node, where the license transfer request includes the block identifier. For example, a customer may wish to cancel the license. Additionally, the block may be lost and as a result, the customer may want to report the loss of the block and issue a new block, for example. Furthermore, for example, the customer may wish to block multiple licenses. As a result, for example, there may be multiple license block requests sent from the customer to the system.

At action 320, the license and subscription management system blocks the transaction ledger block corresponding to the block identifier. For example, when the server blocks the transaction ledger block, the block id will be blocked from receiving updates, and a new block will be sent to the customer node system address. Furthermore, for example, if the customer wants to cancel the license, the block id will be invalidated in the license and subscription management system, which does not require updating the transaction ledger block.

At action 322, the license and subscription management system generates a new transaction ledger block corresponding to the license block transaction, the new transaction ledger block including the customer node system address and the license identifier. In the present example, the license and subscription management system provides the license block transaction, in a transaction ledger block that includes one or more other transactions that have been validated by the license and subscription management system.

In the present example, the license and subscription management system assigns the transaction a transaction identifier. In some examples, the license and subscription management system assigns the transaction identifier by accessing one or more hashes included in previous transaction ledger blocks to perform a proof of work. In more detail, the proof of work may include generating a hash that includes contents from the transaction ledger and also a hash of a previous transaction ledger block. The proof of work helps protect the transaction ledger block (and the previous transaction ledger blocks) from tampering because it provides a cryptographic link between the transaction ledger block and previous transaction ledger blocks. In that regard, the hashes in the transaction identifiers help ensure that even minor changes in the previous transaction ledger block result in a different hash, thereby indicating the existence of the tampering. Moreover, if a previous transaction ledger block is tampered with, it may be identified as out of place in the linked transaction ledgers because other nodes in the network will have copies of the previous transaction ledger block that do not match the tampered-with previous transaction ledger.

At action 324, the license and subscription management system provides the license block transaction ledger block to the customer node and to a transfer node corresponding to the transfer node identifier. In the present example, the license and subscription management system includes the transaction ledger block in a listing of previous transaction ledger blocks, and provides the transaction ledger blocks to the customer node and to the transfer node the corresponds to the transfer node identifier so that the customer node and transfer node may similarly include the transaction ledger block in their listings of previous transaction ledger blocks. In another example, the license and subscription management system includes the transaction ledger block in a listing of previous transaction ledger blocks, and provides the transaction ledger blocks to the other nodes so that the other nodes may similarly include the transaction ledger block in their listing of previous transaction ledger blocks.

FIG. 3d is an illustration 326 of what the generated transaction ledger block 328 may contain, in accordance with various examples of the present disclosure. The generated transaction ledger block 328 may contain, for example, a transaction identifier 330.

In some examples, the transaction identifier 330 includes a hash of one or more of the following: a hash of a location of a license, an identifier of the customer node, an encrypted command, a description of the license, a time stamp, a node location field, or versioning information. In some examples, the transaction identifier 330 also takes into account one or more hashes of previous transactions. The hash may be taken into account by providing a hash tree where leaf nodes in the hash tree are labeled with a hash of a previous transaction, and the non-leaf nodes are labeled with the hashes of labels of their respective child nodes.

In the present example, the generated transaction ledger block 328 may also include a customer node system address.

In the present example, the generated transaction ledger block 328 may also include a license term identifier 334. For example, the license term identifier 334 may indicate how long the customer node may have access to the license. By way of further example, the license term identifier 334 may indicate a period of time that the customer node has access to the license, or the license term identifier 334 may indicate the amount of system resources that the customer node may consume while using the license. Additionally, for example, the generated transaction ledger block 328 may be letters and/or integer numbers.

In the present example, the generated transaction ledger block 328 may also include an encrypted promotion code 336. For example, the encrypted promotion code 336 may automatically extend the license term. For example, a customer's license term may be for a year, but the encrypted promotion code 336 may automatically extend the license term for a period of time, such as for six months. By way of further example, the encrypted promotion code 336 may extend a customer's license term by increasing the limit for the amount of system resources that the customer node may consume for the license term limit.

In the present example, the generated transaction ledger block 328 may also include a block identifier 338. The block identifier 338 may be a unique ID that is specific for the particular generated ledger block. For example, the block identifier 338 may be a cryptographic hash created through a Secure Hash Algorithm, such as, for example, SHA-256. By way of further example, the block identifier 338 may correspond to the height of the generated transaction ledger block in the transaction ledger. By way of further example, the block identifier 338 may consist of letters and/or integer numbers.

In the present example, the generated transaction ledger block 328 may also include a license identifier 340. The license identifier 340 may be, for example, a series of integers and/or letters that uniquely identify the particular license. By way of further example, the license identifier 340 may not just identify the particular license, but also the particular license version number. For example, the license identifier 340 may unlock at least one relevant subscription for use by the customer node 342.

FIG. 3e is an illustration 344 of what the license acquire transaction request 346 may contain, in accordance with various examples of the present disclosure. The license acquire transaction request 346 may contain, for example, a customer node private key 348. The private key may be known by the customer node, and is not shared.

FIG. 4 is an organizational diagram of a computing device 400 suitable for implementing one or more networked computing nodes of a system (e.g., networked computing system 100). In various implementations, computing device 400 may provide a computing device, such as a smart or mobile phone, a computing tablet, a desktop computer, laptop, wearable device, rack mount server, or other computing device.

Computing device 400 may include a bus 402 or other communication mechanisms for communicating information data, signals, and information between various components of computing device 400. Components include an I/O component 404 that processes a user action, such as selecting keys from a keypad/keyboard, selecting one or more buttons, links, actuatable elements, etc., and sends a corresponding signal to bus 402. I/O component 404 may also include an output component, such as a display 406 and a cursor control 408 (such as a keyboard, keypad, mouse, touch screen, etc.). An optional audio I/O component 410 may also be included to allow a user to hear audio and/or use voice for inputting information by converting audio signals.

A network interface 412 transmits and receives signals between computing device 400 and other devices, such as user devices, data storage servers, payment provider servers, and/or other computing devices via a communications link 414 and a network 416 (e.g., such as a LAN, WLAN, PTSN, and/or various other wired or wireless networks, including telecommunications, mobile, and cellular phone networks).

The processor 418 represents one or more general-purpose processing devices such as a microprocessor, central processing unit, or the like. More particularly, processor 418 may be a complex instruction set computing (CISC) microprocessor, reduced instruction set computing (RISC) microprocessor, very long instruction word (VLIW) microprocessor, or a processor implementing other instruction sets or processors implementing a combination of instruction sets. Processor 418 may also be one or more special-purpose processing devices such as an application specific integrated circuit (ASIC), a field programmable gate array (FPGA), a digital signal processor (DSP), network processor, or the like. Processor 418 is configured to execute instructions for performing the operations and steps discussed herein.

Components of computing device 400 also include a main memory 420 (e.g., read-only memory (ROM), flash memory, dynamic random access memory (DRAM) such as synchronous DRAM (SDRAM), double data rate (DDR SDRAM), or DRAM (RDRAM), and so forth), a static memory 422 (e.g., flash memory, static random access memory (SRAM), and so forth), and a data storage device 424 (e.g., a disk drive).

Computing device 400 performs specific operations by processor 418 and other components by executing one or more sequences of instructions contained in main memory 420. Logic may be encoded in a computer readable medium, which may refer to any medium that participates in providing instructions to processor 418 for execution. Such a medium may take many forms, including but not limited to, non-volatile media, volatile media, and/or transmission media. In various implementations, non-volatile media includes optical or magnetic disks, volatile media includes dynamic memory, such as main memory 420, and transmission media between the components includes coaxial cables, copper wire, and fiber optics, including wires that comprise bus 402. In one example, the logic is encoded in a non-transitory machine-readable medium. In one example, transmission media may take the form of acoustic or light waves, such as those generated during radio wave, optical, and infrared data communications.

Some common forms of computer readable media include, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, or any other medium from which a computer is adapted to read.

In various examples of the present disclosure, execution of instruction sequences to practice the present disclosure may be performed by computing device 400. In various other examples of the present disclosure, a plurality of computing devices coupled by communication link 414 to the network 416 may perform instruction sequences to practice the present disclosure in coordination with one another. Modules described herein may be included in one or more computer readable media or be in communication with one or more processors to execute or process the steps described herein.

In the foregoing description, numerous details are set forth. It will be apparent, however, to one of ordinary skill in the art having the benefit of this disclosure, that the present disclosure may be practiced without these specific details. In some instances, well-known structures and devices are shown in block diagram form, rather than in detail, in order to avoid obscuring the present disclosure. Although illustrative examples have been shown and described, a wide range of modification, change and substitution is contemplated in the foregoing disclosure and in some instances, some features of the examples may be employed without a corresponding use of other features. In some instances, actions may be performed according to alternative orderings. One of ordinary skill in the art would recognize many variations, alternatives, and modifications. Thus, the scope of the invention should be limited only by the following claims, and it is appropriate that the claims be construed broadly and in a manner consistent with the scope of the examples disclosed herein.

What is claimed is:

1. A system, comprising:
a non-transitory memory; and
one or more hardware processors coupled to the non-transitory memory and configured to read instructions from the non-transitory memory to cause the system to perform operations comprising:
receiving a license acquire transaction request from a customer node, the license acquire transaction request including a customer node system address;
validating the license acquire transaction, the validating including authenticating the customer node;
generating a transaction ledger block corresponding to the license acquire transaction, the transaction ledger block including a block identifier and a license identifier; and
providing the generated transaction ledger block to the customer node.

2. The system of claim 1, further comprising:
receiving a system update request from the customer node, the system update request including the customer node system address;
determining a license status corresponding to the customer node system address; and
approving the system update request, in response to determining that the license status is current.

3. The system of claim 1, further comprising:
receiving a license transfer request from the customer node, the license transfer request including the customer node system address and a transfer node identifier;
generating a license transfer transaction ledger block corresponding to the license transfer transaction, the license transfer transaction ledger block including the transfer node identifier and the license identifier; and
providing the generated license transfer transaction ledger block to the customer node and a transfer node corresponding to the transfer node identifier.

4. The system of claim 1, further comprising:
receiving a license block request from the customer node, the license block request including the block identifier;
blocking the transaction ledger block corresponding to the block identifier;
generating a new transaction ledger block corresponding to the license block transaction, the new transaction ledger block including the customer node system address and the license identifier; and
providing the new generated transaction ledger block to the customer node.

5. The system of claim 1, wherein a license corresponding to the license identifier unlocks at least one relevant subscription for use by the customer node.

6. The system of claim 1, wherein the generated transaction ledger block includes a transaction identifier, the customer node system address, and a license term identifier.

7. The system of claim 6, wherein the generated transaction ledger block further includes an encrypted promotion code, wherein the encrypted promotion code extends the license term identifier.

8. The system of claim 1, wherein the license acquire transaction request includes a customer node private key.

9. A non-transitory machine-readable medium having stored thereon machine-readable instructions executable to cause a machine to perform operations comprising:
receiving a license acquire transaction request from a customer node, the license acquire transaction request including a customer node system address;
validating the license acquire transaction, the validating including authenticating the customer node;
generating a transaction ledger block corresponding to the license acquire transaction, the transaction ledger block including a block identifier and a license identifier; and
providing the generated transaction ledger block to the customer node.

10. The non-transitory machine-readable medium of claim 9, further comprising:
receiving a system update request from the customer node, the system update request including the customer node system address;
determining a license status corresponding to the customer node system address; and
approving the system update request, in response to determining that the license status is current.

11. The non-transitory machine-readable medium of claim 9, further comprising:
receiving a license transfer request from the customer node, the license transfer request including the customer node system address and a transfer node identifier;
generating a license transfer transaction ledger block corresponding to the license transfer transaction, the license transfer transaction ledger block including the transfer node identifier and the license identifier; and
providing the generated license transfer transaction ledger block to the customer node and a transfer node corresponding to the transfer node identifier.

12. The non-transitory machine-readable medium of claim 9, further comprising:
receiving a license block request from the customer node, the license block request including the block identifier;
blocking the transaction ledger block corresponding to the block identifier;
generating a new transaction ledger block corresponding to the license block transaction, the new transaction ledger block including the customer node system address and the license identifier; and
providing the new generated transaction ledger block to the customer node.

13. The non-transitory machine-readable medium of claim 9, wherein a license corresponding to the license identifier unlocks at least one relevant subscription for use by the customer node.

14. The non-transitory machine-readable medium of claim 9, wherein the generated transaction ledger block includes a transaction identifier, the customer node system address, and a license term identifier.

15. The non-transitory machine-readable medium of claim 14, wherein the generated transaction ledger block further includes an encrypted promotion code, wherein the encrypted promotion code extends the license term identifier.

16. A method comprising:
receiving a license acquire transaction request from a customer node, the license acquire transaction request including a customer node system address;
validating the license acquire transaction, the validating including authenticating the customer node;
generating a transaction ledger block corresponding to the license acquire transaction, the transaction ledger block including a block identifier and a license identifier; and
providing the generated transaction ledger block to the customer node.

17. The method of claim 16, further comprising:
receiving a system update request from the customer node, the system update request including the customer node system address;
determining a license status corresponding to the customer node system address; and
approving the system update request, in response to determining that the license status is current.

18. The method of claim 16, further comprising:
receiving a license transfer request from the customer node, the license transfer request including the customer node system address and a transfer node identifier;
generating a license transfer transaction ledger block corresponding to the license transfer transaction, the license transfer transaction ledger block including the transfer node identifier and the license identifier; and.
providing the generated license transfer transaction ledger block to the customer node and a transfer node corresponding to the transfer node identifier.

19. The method of claim 16, further comprising:
receiving a license block request from the customer node, the license block request including the block identifier;
blocking the transaction ledger block corresponding to the block identifier;
generating a new transaction ledger block corresponding to the license block transaction, the new transaction ledger block including the customer node system address and the license identifier; and
providing the new generated transaction ledger block to the customer node.

20. The method of claim 16, wherein a license corresponding to the license identifier unlocks at least one relevant subscription for use by the customer node.
